(19) United States
(12) Patent Application Publication
(10) Pub. No.: US 2003/0223586 A1
(43) Pub. Date: Dec. 4, 2003

(54) Method and system for secure communications over a communications network

(76) Inventors: Edward Green, Lee, MA (US); Aram Perez, Carmichael, CA (US); Dennis Sears, Sheffield, MA (US)

Correspondence Address: BAKER & BOTTS, 30 ROCKEFELLER PLAZA, NEW YORK, NY, 10112

(21) Appl. No.: 10/223,201

(22) Filed: Aug. 19, 2002

Related U.S. Application Data
(60) Provisional application No. 60/384,347, filed on May 30, 2002.

(51) Int. Cl. H04L 9/00

(52) U.S. Cl. 380/283

(57) ABSTRACT

Disclosed is a method and system for securely communicating between an initiating user at an initiating system and a destination entity. In one aspect, the system includes a general purpose processor, a security processor, secure memory, a human interpretable data input device for receiving secure human interpretable data and insecure human interpretable data, a cryptographic module, an interface for interfacing the security processor with the general purpose processor so that the general purpose processor is able to access secure human interpretable data only after the secure human interpretable data has been encrypted by the encryption module and is able to access the insecure human interpretable data in unencrypted form, and a transmitter for transmitting encrypted secure human interpretable data to a destination entity. In another aspect, the method includes a protocol for secure communications using the system of the present invention.

### RELATED APPLICATION

This application claims priority from U.S. provisional application No. 60/384,347, entitled “Method and System For Secure Tunnel Communications Over A Communications Network,” filed on May 30, 2002, which is incorporated by reference herein.

### BACKGROUND OF INVENTION

Computers and the wide spread adoption of multi-user computer networks, such as the Internet, have made instant digital communications between persons a reality. It is well-known, however, that these computer networks are not secure, and digital communications flowing along these networks may be intercepted or subverted by malicious users with access to the communications data as it passes along the communications path. Numerous techniques have been proposed to counteract the possibility of malicious eavesdroppers, such as encrypting the communications between the communicating parties. Those techniques are well-known to persons of ordinary skill in the art and include using private/public key encryption such as the RSA algorithm and/or session key encryption, such as the DES or 3DES algorithms. However, these encryption methods are typically carried out by a general purpose processor present in the computers of the communicating parties. Thus, it is possible for an eavesdropper to intercept or alter the communications before they reach the general purpose processor of the transmitting party for encryption or after they have been decrypted by the general purpose processor of the receiving party.

Specifically, many modem personal computers (PC) running operating systems such as Windows™ receive input from a human interpretable data input device, such as a keyboard, using a standardized interface, such as the Human Interface Device (HID) interface, which is part of the Windows™ operating system. In that environment, one can utilize well-known methods to interfere with the keyboard-to-PC communications and, in fact, “capture” the keystroke information from the keyboard to the PC, thereby subverting and/or intercepting the communications. An eavesdropper may surreptitiously install on a PC, or cause a user at a PC to unwittingly install, an application that causes the general purpose programmable processor in that PC to store all keystrokes entered by a user, or other data transmitted from a human interpretable data input device, at that PC or to secretly transmit all such data received at that PC to a remote computer. Alternatively, the eavesdropper may interfere with the data entered at a PC by replacing that data with other data.

### SUMMARY OF THE INVENTION

The present invention, in one aspect, allows secure entry of data such that the normal peripheral-PC-Windows communications path and associated processing of the entered data are replaced with a trusted computer environment secure communications path.

In an exemplary embodiment, the invention makes use of the trusted computing environments described in U.S. Pat. No. 6,092,202, entitled “Method and System For Secure Transactions In A Computer System” to Leonard Veil, Gary Ward, Richard Alan and Eric Alan, issued on Jul. 18, 2000, incorporated herein by reference, or U.S. Pat. No. 6,138,239, entitled “Method and System For Authenticating And Utilizing Secure Resources In A Computer System,” to Leonard Veil, issued on Oct. 24, 2000, also incorporated herein by reference. Those patents disclose secure computing environments that make use of trusted input devices or secure peripherals as well as secure processors to process data in a trusted, secure environment, such that sensitive data is not provided in an unencrypted form to any untrusted resources, such as general purpose processors present on the host computer or untrusted displays.

The exemplary embodiment utilizes a security processor and secure memory coupled to the security processor. A human interpretable data input device, such as a keyboard, is also utilized. The input device receives human interpretable data, which may be either secure input data, which is not to be provided in unencrypted form to the general purpose processor on the host computer, or insecure input data, which may be shared in unencrypted form with the general purpose processor on the host computer. The exemplary embodiment makes use of a cryptographic module, which is coupled to the security processor, to encrypt human interpretable data when that data is secure. The exemplary embodiment also utilizes an interface between the general purpose processor of the host computer and the security processor. The interface includes a protocol that restricts the ability of the general purpose processor to access the human interpretable input data so that the general purpose processor is able to access secure human interpretable input data only after it has been encrypted, but may access insecure human input interpretable data in an unencrypted form. Coupled to the general processor of the host computer is a transmitter for sending encrypted secure human interpretable data over a communications path to recipient at a remote apparatus, such as a computer.

The system may optionally securely display the entered keystrokes on a secure display, such as a trusted LCD display or other display technology. The trusted LCD display may be a part of the secure keyboard peripheral and share a common secure processor.

In another exemplary embodiment, the security processor, secure memory, human interpretable data device, cryptographic module, secure display and general purpose processor interface are all combined in a single secure keyboard.

In another aspect of the present invention, a method is provided for initiating and conducting a secure communications session with a remote apparatus. The method includes transmitting a request for a chat invitation from a general purpose processor on a host computer to a security processor. The security processor then generates a chat invitation message. The invitation message is transmitted to the remote apparatus. A responsive chat challenge message is received from the remote apparatus. The security processor then generates a chat response message, which is transmitted to the remote apparatus. A responsive chat accepted message, including a communications key in encrypted form, is received from the remote apparatus. The chat accepted message is validated by the security processor, including decrypting the communications key, and, if validation is successful, at least one communications message is encrypted using the communications key and the encrypted message is transmitted to the remote apparatus.

### BRIEF DESCRIPTION OF THE DRAWINGS

For a more complete understanding of the present invention, reference is made to the following detailed description of exemplary embodiments with reference to the accompanying drawings in which:

FIG. 1 is a schematic diagram illustrating an overview of a communications system in accordance with an exemplary embodiment of the present invention;

FIG. 2 is a schematic diagram illustrating a more detailed view of the system illustrated in FIG. 1;

FIG. 3 is a process diagram illustrating an overview of a communications session in accordance with an exemplary embodiment of the present invention;

FIG. 4 is a process diagram illustrating a more detailed view of the initiation of the communication session illustrated in FIG. 3;

FIG. 5 is a process diagram illustrating a more detailed view of the secure session phase of the communication session illustrated in FIG. 3;

FIG. 6 is a process diagram illustrating a more detailed view of the termination of the communication session illustrated in FIG. 3;

FIG. 7 is a diagram of a digital certificate structure useful in an embodiment of the present invention; and

FIG. 8 is a diagram of a certificate chain useful in an embodiment of the present invention.

### DETAILED DESCRIPTION OF THE EXEMPLARY EMBODIMENTS

FIG. 1 illustrates a conceptual overview of the overall architecture of the present invention. As illustrated, a secure communications channel 111 between a trusted human interpretable data input device, such as secure keyboard 103 of a computer (“PC”) 101, and a trusted human interpretable data output device, such as a secure LCD as part of keyboard 107 of a computer (“PC”) 105, is provided.

As used herein, “human interpretable data” is data that, when decoded and rendered, may be directly apprehended by a human. For example, human interpretable data may be: alpha-numeric information in a language or code understandable to the human individual(s) receiving that data, audio information that when rendered by a speaker is capable of being appreciated or understood by the human recipient, visual information, such as still or moving images, and/or any combination of this type of data. As used herein, “human interpretable data input device” is any device capable of receiving human interpretable data, and may include a keyboard, a microphone, a camera, or similar device. As used herein, “human interpretable data output device” is any device capable of rendering human interpretable data for direct presentation to a human, and may include a display, a speaker, or other similar device.

The communications occur via a physical network 109, which may be any computer network, or network of networks, such as a LAN, WAN and/or the Internet. Use may be made of Ethernet cards, telephone line modems, cable modems, other network interface devices, or any combination thereof to establish a communications path between each PC 103, 104 and the physical network 109. The secure communications channel 111 ensures that sensitive information is encrypted at the transmitting keyboard 103 before the information is transmitted to the PC 101 connected to the trusted input device for transmission over the network 109 to the destination PC 105.

At the receiving end, the sensitive information is passed in its encrypted form from the receiving PC 105 to the recipient's trusted output device where the information is decrypted and rendered, such as on an embedded LCD display or similar display device (not shown) on trusted input device 107.

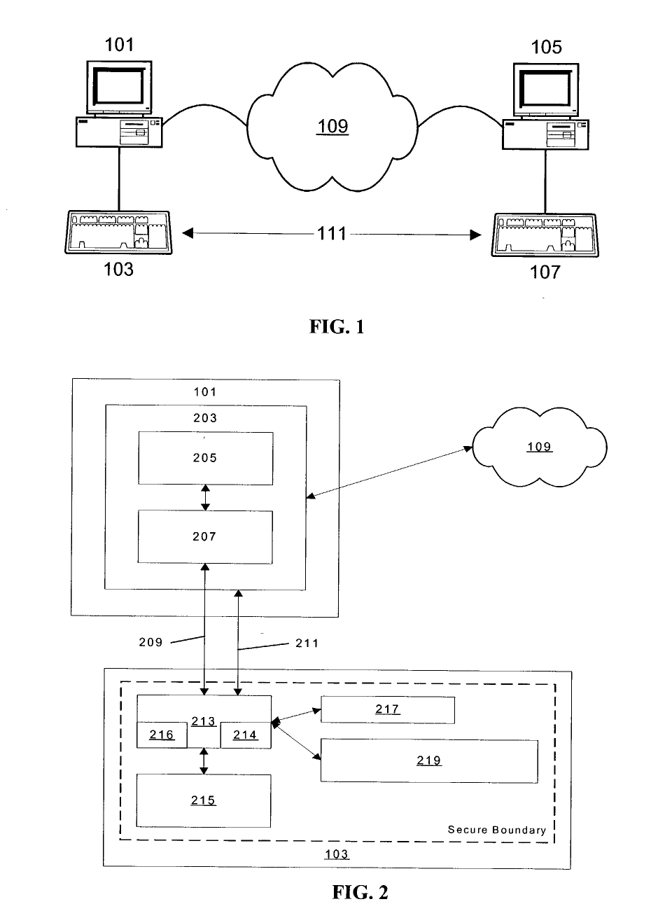

FIG. 2 illustrates a more detailed depiction of PC 101 and trusted human interpretable data input device 103 coupled thereto. The PC 101 includes a general purpose processor 203, such as an Intel Pentium™ processor running a PC operating system 205 such as Microsoft Windows™. In prior systems, information from a keyboard would be transmitted to the processor 203 in an unencrypted manner via keystroke path 211. Accordingly, malicious programs running on processor 203 could intercept the transmitted keyboard data arriving via path 211 and store that data or surreptitiously transmit that data via network 109 to another computer (not shown) where the data is received and utilized by a party unauthorized to receive the data. In the present invention, this possibility is eliminated by trusted keyboard 103 and secure interface 209.

Data entered at the trusted keyboard 103 via keys 219 are received by a security processor 213 and stored in secure memory 214. Secure memory 214 may be memory circuits built into the secure processor chip, or may be separate memory circuits. Secure memory 214 is any conventional memory device, and may be RAM, flash memory, other suitable memory devices or a combination thereof. Access to secure memory 214 is controlled by security processor 213, so that general purpose processor 203 may not access the contents of secure memory 214 without authorization from the security processor 213.

The data received from keys 219 may be processed by a cryptographic module 216 to encrypt the data before it is made available to general purpose processor 203. The cryptographic module 216 may make use of any encryption scheme, such as the well-known private/public key encryption schemes, including the RSA algorithm, and/or session key encryption schemes, such as the DES, 3DES or AES algorithms. The cryptographic module may be a hardware device, such as a dedicated encryption processor, or it may be a software module running within security processor 213 and secure memory 214. Regardless of whether the cryptographic module is embodied in hardware or software, it is controlled by security processor 213, such as by a “trustlet” 215, described in further detail herein, running within security processor 213.

As used herein, the term “trustlet” means a secure executable software routine or combination of routines that runs in a secure processing environment, such as in secure processor 213 and secure memory 214.

The cryptographic module 216 may encrypt all data input at keys 219, or it may encrypt only data input at keys 219 that is secure. During the phase of operation of PC 101 when secure communications are not essential, the security processor 213 passes user data input via keys 219 from secure memory 214 to general purpose processor 203 via communication path 211, where the data may be processed by PC operating system 205 using well-known techniques. For example, when a user is operating a word processing application (not shown) running on general purpose processor 203, the keystrokes entered on keys 219 may be passed in unencrypted form directly from security processor 213 to processor 203 running operating system 205. The operating system may then pass the human interpretable data to the word processing application (not shown), where the input data is processed.

Alternatively, when the user of PC 101 desires to establish secure communications via network 109, he or she may invoke a secure communications application 207 running on general purpose processor 203. This secure communication application 207 makes use of an interface 209 for communicating with the security processor 213. The interface 209 is an application programming interface for interfacing with security processor 213. Security processor 213, in response to information received from communications application 207 over the interface 209, invokes a secure communications chat trustlet 215, which is a software module for handling secure communications, and may be stored in secure memory 214. As described in more detail herein with reference to FIGS. 3-6, the chat trustlet manages human interpretable data input device 103 so that secure human interpretable input data is not transmitted in an unencrypted form to processor 203. Instead, secure input is encrypted via an encryption module before it is made available to processor 203 via interface 209.

Human interpretable data input device 103 optionally includes secure display 217. This display may be an LCD display for outputting decrypted text received from another user with whom the user of PC 101 is communicating. Alternatively, or in addition, display 217 may display the data that has been input by the user via keys 219 before the data is securely transmitted to the user with whom the user at PC 101 is securely communicating.

Referring now to FIG. 3, an exemplary embodiment of the previously described chat application and chat trustlet is illustrated. As shown in FIG. 3, a secure chat application and trustlet is running on a computer 301 of a party wishing to securely communicate as well as on a computer 303 of a party with whom that party wishes to communicate. In the exemplary embodiment described, the chat application and trustlet running on computer 301 is identical to the chat application and trustlet running on computer 303; however, it is not essential that the application and trustlet be identical as long as they are able of performing the functions described herein. For instance, the party using computer 303 may not make use of a security processor at all, instead utilizing a general purpose processor to conduct the secure communications. Such an embodiment might be useful where the user of computer 303 was certain that no rogue application was running on the general purpose processor that was capable of intercepting or modifying data received from a keyboard attached to the computer 303.

The communication session between the user at computer 301 and the user at computer 303 consists of a session establishment phase, a secure session phase and a session termination phase. Each of the phases is described in detail in turn.

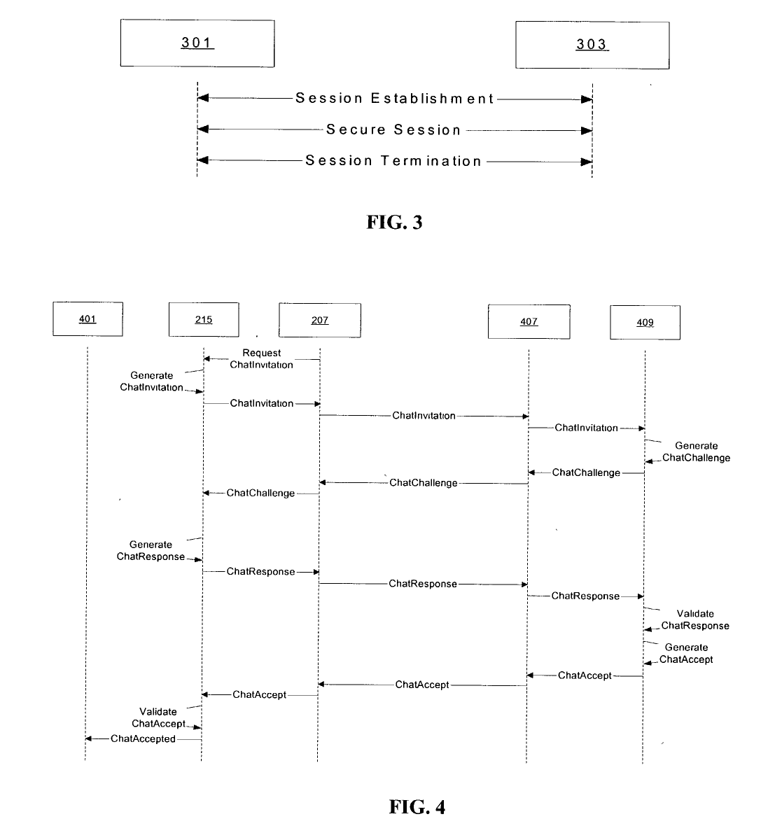

FIG. 4 illustrates further details of the session establishment phase of one exemplary embodiment of the chat application 207 and trustlet 215 illustrated in FIGS. 2 and 3. The establishment phase begins with a chat invitation being requested by chat application 207 running on the general purpose processor 203 of computer 301. The request may be generated in response to the user interacting with the general purpose processor 203 on computer 301 to indicate that he desires to begin a secure communication session with a user at a remote computer. General purpose processor 203 then communicates with chat trustlet 215 running on security processor 213 via interface 209 to request generation of the Chat Invitation message. The Chat Invitation is generated and passed via interface 209 to chat application 207. In the exemplary embodiment, all messages between computer 301 and computer 303 use a “Secure Chat Message”, which is defined in Abstract Syntax Notation (ASN. 1) as follows:

SecureChatMessage ::= SEQUENCE {

version SecureChatMessageVersion,
chatMessage ChatMessage

}
SecureChatMessageVersion ::= INTEGER
(RANGE(1..255)) { scmVer1 (1)
} (scmVer1)
ChatMessage ::= CHOICE {

| | |
|---|---|
| chatInvitation | [0] ChatInvitation, |
| chatChallenge | [1] ChatChallenge, |
| chatResponse | [2] ChatResponse, |
| chatAccept | [3] ChatAccept, |
| chatMessage | [4] ChatMessage, |
| chatStop | [5] ChatStop} |

where scmVer1 is an integer number that reflects the version of the SecureChatMessage to which the message corresponds. This number is provided to allow compatibility between different versions of the application and trustlet software if the format of the SecureChatMessage changes over time in new versions of the chat application and/or chat trustlet. In the exemplary embodiment, scmVer1 is 1.

Although Abstract Syntax Notation is used herein to describe the format of messages in the exemplary secure communications session, the actual implementation of the message may be in any suitable format such as ASCII or XML.

The chat invitation message that is generated by the secure processor, in the exemplary embodiment, is of the following form:

ChatInvitation ::= SEQUENCE {

version ChatInvitationVersion,

}
ChatInvitationVersion ::= INTEGER (RANGE(1..255)) {

ciVer1 (1) } ( ciVer1 )

where ciVer1 is an integer number that reflects the version of the ChatInvitation message to which the message corresponds. This number is provided to allow compatibility between different versions of the application and trustlet software if the format of the SecureChatMessage changes over time in new versions of the chat application and/or chat trustlet. In the exemplary embodiment, ciVer1 is 1.

The general purpose processor 203 then passes the Chat Invitation message as a Secure Chat Message, previously described, over network 109 to remote computer 303, where the message is received by the general purpose processor on the destination computer running a chat application 407, which may be identical to chat application 207. The received Chat Invitation message informs the receiving computer that a user at computer 301 wishes to initiate a secure communications session with a user at the receiving computer. The received Chat Invitation message is passed to a chat trustlet 409, which may be identical to chat trustlet 215 and may be running on a security processor, such as security processor 213, at the destination computer.

Chat trustlet 409 at the destination computer generates a Chat Challenge message in response to the received Chat Invitation message. In the exemplary embodiment, the Chat Challenge message includes a random sequence of sixteen bytes to be sent to the originating computer in order for authentication, as described in further detail herein. In the exemplary embodiment, the Chat Challenge message has the following form:

ChatChallenge ::= SEQUENCE {

version ChatChallengeVersion,
challenge Challenge,

}
ChatChallengeVersion ::= INTEGER (RANGE(1..255))

{ ccVer1 (1) } ( ccVer1 )

Challenge ::= OCTET STRING (SIZE(16)) -- 16 random bytes

where ccVer1 is an integer number that reflects the version of the ChatChallenge message to which the message corresponds. This number is provided to allow compatibility between different versions of the application and trustlet software if the format of the ChatChallenge changes over time in new versions of the chat application and/or chat trustlet. In the exemplary embodiment, ccVer1 is 1.

The Chat Challenge message is passed to chat application 407, then over network 109 to the chat application 207 of the originating computer, which passes the received message to the chat trustlet 215 running on the security processor 213 to generate a response.

Chat trustlet 215 generates a Chat Response message in response to the Chat Challenge message. The Chat Response message includes the original random sequence of sixteen bytes concatenated with another random sequence of sixteen bytes generated by the chat trustlet 215 running on the secure processor 213. The Chat Response message also includes a copy of the concatenated thirty-two byte random sequence digitally-signed by the user originating the chat session. The details of digital signatures will now be discussed.

Public-private-key cryptography algorithms utilize a key-pair of a public key and a private key for authentication and encryption. The public key is data available in the public domain. The private key is sensitive data personal to its owner. Accordingly, private keys are typically stored in secure memory, such as on a smart card, or secure memory 214 illustrated in FIG. 2.

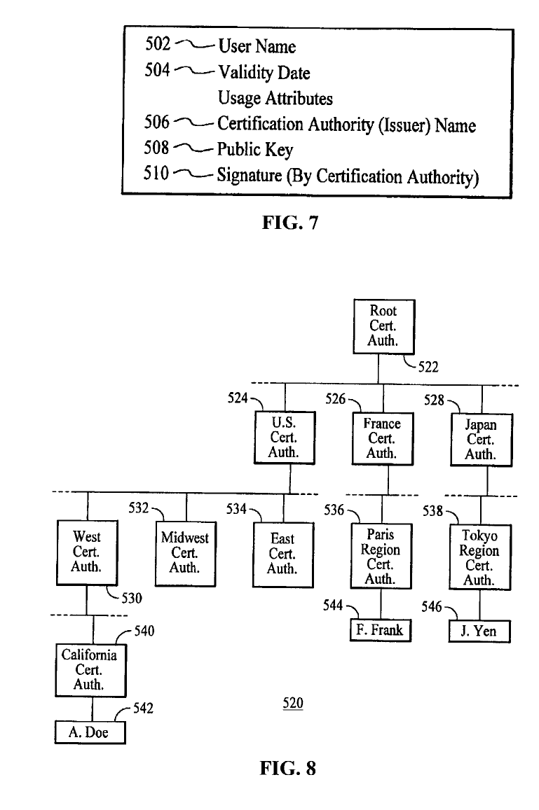

A digital certificate binds the key-pair to a name, thus providing a digital identity. The digital certificate is used to verify that the public key belongs to the particular entity using it. FIG. 7 is a diagram of a conventional certificate structure. A conventional certificate structure conforms, for example, with the X509.v3 standard certificate structure. A conventional digital certificate as shown in FIG. 7 includes a user name 502, a certificate validity date 504, and the public key 508. The certificate is “signed” by a mutually trusted authority (i.e., trusted by the public-key user and the party with whom he or she is communicating). The mutually trusted authority, commonly known as the certificate authority or issuing authority 506, authenticates the public key user identity by providing a signature 510, verifying that the public key 208 really belongs to the public key user 502.

With public-private-key cryptography, a message, encrypted or unencrypted, can be “signed” with the private key using well-known algorithms and transmitted to an addressee. The addressee, or anyone having the corresponding public key, can use the public key to decipher the message and confirm who sent it. Digital certificates allow authenticating messages by tracing the messages to their source and a common point of trust, usually referred to as a “root” entity. Usually, a certificate chain is used for this purpose. Typically, rather than applying the “signature” directly to the document to be signed, the user will “hash” the document to be signed, using well-known techniques. The resultant “hash” uniquely corresponds to the content of the document, but the text of the document may not be recovered from the hash. This hash is then encrypted, using the private key of the user signing the document, and the signed hash is transmitted either together with or without the original document. The recipient may then decrypt the received hash using the public key of the signing user to recover the hash and verify that the signing user “signed” and sent the document.

FIG. 8 is a diagram of a certificate chain for authenticating electronic communications. A certificate chain having a root certification authority 522 allows individuals in different countries and regions to electronically communicate with each other. The root certification authority 522 allows certification authorities in various countries, and regions within those countries, to issue digital identities to individuals. The certificate chain creates a trust relationship where trust flows upwards from each transaction party to the root certification authority 522.

“Trust relationship” relates to a relationship existing between two devices, entities or users that enables: (1) authentication (it should be possible for the receiver of a message to ascertain its origin; an intruder should not be able to masquerade as someone else); and (2) integrity (it should be possible for the receiver of a message to verify that it has not been modified in transit; an intruder should not be able to substitute a false message for a legitimate one).

For example, there may be a Japanese certification authority 528, a French certification authority 526, and a U.S. certification authority 524, each issuing digital identities to Japanese, French and U.S. residents, respectively. In Japan, a Tokyo region certification authority 538 may issue a digital identity 546 to J. Yen. In France, a Paris region certification authority 536 may issue a digital identity 544 to F. Frank. In the U.S., there may be an East certification authority 534, a Mid-west certification authority 532 and a West certification authority 530. The West certification authority 530 may issue a digital identity to a California certification authority 540 which, in turn, may issue a digital identity 542 to A. Doe.

When A. Doe, a California resident, wants to communicate with J. Yen in Japan and/or with F. Frank in France, A. Doe needs to be sure that the electronic communications are conducted with J. Yen and/or F. Frank and not with imposters. Through existing certificate technology, it is possible to verify the digital identity of a sender of transaction messages by traversing upwards through the certificate chain. In checking the digital certificate in someone's message, A. Doe can check if there is a valid digital identity in the person's digital certificate. That is, A. Doe can check if in J. Yen's message there are valid certification authority signatures of the Tokyo region certification authority 538, the Japan certification authority 528, and the root certification authority 522.

Public-private-key cryptography is characterized in that it is an asymmetric cryptography wherein if transformation (encryption) is done with the user's public-key, only the user's private-key will do the reverse transformation (decryption). That is, only one of the keys is needed on each side, one for the transformation and the other for the reverse transformation, respectively.

In contrast, symmetric key cryptography uses one key, which both sides use to encrypt and decrypt their messages. One side encrypts a message using the key, and the other side uses the same key to decrypt the message. This key must be kept secret; if an unauthorized person obtains the key, he or she can read all the communications encrypted with that key. Thus, key distribution is a critical concern—there are no public keys that can be freely distributed, all keys must be kept secret and a highly secure distribution scheme must be devised to preserve the security of the system. Private-public-key systems allow parties to communicate securely. Since the public keys can be widely distributed, anyone can get a copy of the public key for a person with whom they wish to communicate securely and encrypt a message to them in their public key while authenticating that user via his/her digital certificate.

Referring back to FIGS. 2, 3 and 4, the chat trustlet 215 signs the previously discussed concatenated chat challenge byte sequence using the private key of the user at computer 301 and includes the signed sequence in the Chat Response message. As previously discussed, this “signature” may involve encryption of a hashed version of the concatenated chat challenge byte sequence, using the user's private key. Also optionally included in the Chat Response message is a certificate chain including the digital certificate with associated public key of the user at computer 301. The format of the Chat Response message generated by chat trustlet 215 is:

ChatResponse ::= SEQUENCE {

version ChatResponseVersion,
challenge Challenge, -- From the ChatChallenge
respChallenge Challenge,
signature Signature, -- Over [challenge |
respChallenge]
certChain CertificateChain

}
ChatResponseVersion ::= INTEGER (RANGE(1..255))

{ crVer1 (1) } ( crVer1 )

CertificateChain ::= SEQUENCE OF Certificate
-- Starting from Root, chained Subject to Issuer until user

where crVer1 is an integer number that reflects the version of the ChatResponse message to which the message corresponds. This number is provided to allow compatibility between different versions of the application and trustlet software if the format of the ChatResponse changes over time in new versions of the chat application and/or chat trustlet. In the exemplary embodiment, crVer1 is 1.

The Chat Response message is passed from chat trustlet 215 to chat application 207, where it is sent across network 109 to the computer 303 of the party with whom the user at computer 301 wishes to communicate. The Chat Response message is received by a chat application 407 and passed to chat trustlet 409 to validate the response and to generate an acceptance message if the Chat Response is validated.

Chat trustlet 409 will determine whether the received Chat Response message is valid. In the exemplary embodiment, this validation entails determining whether the digital certificate of the originating user at computer 301 is current and signed by a trusted entity and whether the originating user has transmitted a signed version of the chat challenge byte sequence.

Upon validating the Chat Response message, secure chat trustlet 409 generates a Chat Accept message to indicate to the originating user's computer 301 that the chat invitation has been accepted. The Chat Accept message includes a session key for encryption of messages to be transmitted between the parties during the communications session. Trustlet 409 generates, in the exemplary embodiment, a 3DES or AES session key for encrypting communications between the user at computer 301 and computer 303 during their communications session. After it is generated, the session key is encrypted using the public key of the originating user at computer 301. In the exemplary embodiment, the public key was received by computer 303 in the preceding Chat Response message. In the exemplary embodiment, the session key is further digitally signed using the private key of the user at computer 303. While the Chat Accept message format of the exemplary embodiment makes use of a signed version of the plaintext session key, the signature could be over the encrypted version of the session key instead. In either event, the Chat Accept message does not include an unencrypted version of the session key, therefore eavesdroppers along the communications path will not be able to uncover the session key. A certificate chain of the user at computer 303, similar to the previously discussed certificate chain included in the Chat Response message, is also included in the Chat Accept message. In the exemplary embodiment, the Chat Accept message is of the following form:

ChatAccept ::= SEQUENCE {

version ChatAcceptVersion,
encSessionKey EncryptedSessionKey,
signature Signature, -- Over plain text sessionkey
certChain CertificateChain

}
ChatAcceptVersion ::= INTEGER (RANGE(1..255))

{ caVer1 (1) } ( caVer1 )

-- The EncryptedSessionKey is a 3DES key encrypted by
-- the public key received in the Chat Response.
EncryptedSessionKey ::= OCTET STRING

where caVer1 is an integer number that reflects the version of the ChatAccept message to which the message corresponds. This number is provided to allow compatibility between different versions of the application and trustlet software if the format of the ChatAccept changes over time in new versions of the chat application and/or chat trustlet. In the exemplary embodiment, caVer1 is 1.

The Chat Accept message is transmitted from the chat trustlet 409 to the chat application 407, over network 109 to the chat application 207 on the computer 301 of the originating user. The Chat Accept message is then transmitted to the chat trustlet 215 on the secure processor 213 of the computer 301 of the originating user, where the message is validated. Validation includes verifying that the received digital certificate of the user at computer 303 is valid and further includes decrypting the received session key using the private key of the user at computer 301. Validation may further include verifying that the session key (or the encrypted version of the session key) was properly signed by the private key of the user at computer 303. Following validation, the communication session is established and secure messages may be transmitted between the users at computers 301 and 303.

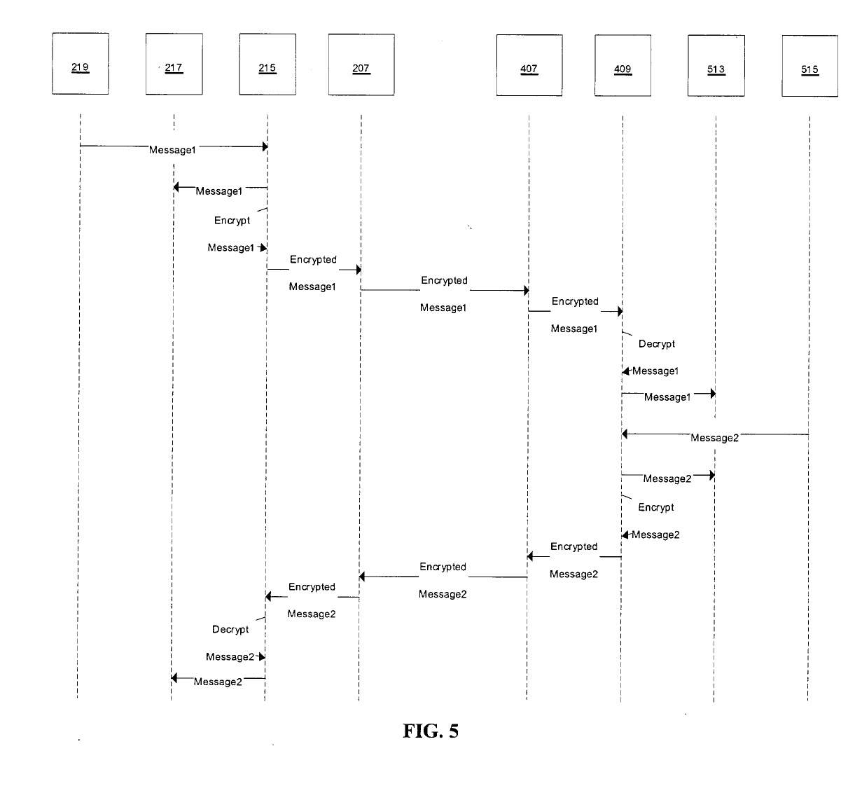

Further detail of the secure session phase of the communications session illustrated in FIG. 3 is shown in FIG. 5. A secure communication begins by inputting human interpretable input data constituting a message, such as using keys 219, previously discussed with reference to FIG. 2. The input message is sent to trustlet 215, where it is processed, which includes encrypting the message using previously received session key using the 3DES, or other suitable algorithm, such as AES. The input data may be sent to a secure display 217, such as an ordinary LCD display, under control of secure processor 213 so that the user entering data on the keys 219 may review the message as it is being entered to verify its accuracy and content. In the exemplary embodiment, the trustlet forms a Chat Message from the input message data, which is to be transmitted to the receiving user at computer 303, of the form:

ChatMessage ::= SEQUENCE {

version ChatMessageVersion,
encMessage EncryptedMessage

}
ChatMessageVersion ::= INTEGER (RANGE(1..255))

{ cmVer1 (1) } ( cmVer1 )

-- A message encrypted by the 3DES session key
EncryptedMessage ::= OCTET STRING

where cmVer1 is an integer number that reflects the version of the ChatMessage message to which the message corresponds. This number is provided to allow compatibility between different versions of the application and trustlet software if the format of the ChatMessage changes over time in new versions of the chat application and/or chat trustlet. In the exemplary embodiment, cmVer1 is 1.

The Chat Message is forwarded to the chat application, which transmits the message over network 109 to receiving computer 303. At the receiving computer 303, the message is received by a chat application 407, which may be identical to chat application 207 of the transmitting computer 301. The chat application transmits the Chat Message to a chat trustlet 409, which may be identical to chat trustlet 215 of the transmitting computer 301. Chat trustlet 409 then decrypts the received message using the previously established session key. The decrypted message is then transmitted to a secure display 513 on computer 303, such as an ordinary LCD display that is controlled by a secure processor, such as secure processor 213 at the receiving computer 303. A user at computer 303 may read the decrypted message on the LCD.

After receiving the decrypted message at computer 303, the user at that computer may transmit a message to the originating user at computer 301. The process of encrypting and transmitting a message from computer 303 to computer 301 is identical to the process of transmitting a message from computer 301 to computer 303, previously described. For instance, input data entered via keys 515 may be transmitted to the trustlet 409 for encryption. Trustlet 409 encrypts the entered data using the previously-established session key and transmits the encrypted message to chat application 407. The message is then transmitted over the network 109 to computer 301, where it is received by chat application 207 and transmitted to trustlet 215 where it is decrypted using the session key and displayed to the user at computer 301.

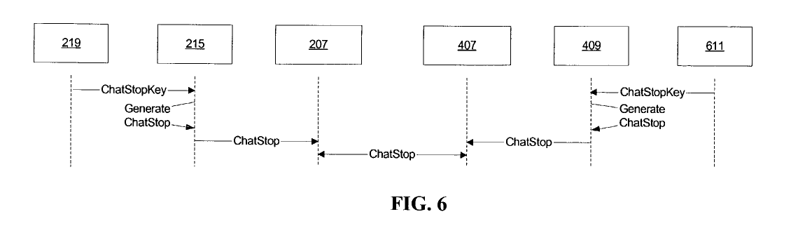

Once either communicating party is ready to terminate the secure communications session, he or she signals the chat trustlet on his or her computer 301 or 303 to generate a Chat Stop message. This may be done activating one of the keys on keyboard 219, entering a key sequence on keyboard 219 or by other another input device, such as a mouse. The signal to generate the Chat Stop message may also come from the chat application 207 running on general purpose processor 203. Further details of the chat termination phase of the communications session is illustrated in FIG. 6.

As shown in FIGS. 3 and 6, the signal to terminate the chat session is entered by one of the communicating users, such as by activating a chat stop key on keyboard 219 of the originating computer 301, or a key on keyboard 611 of the receiving computer 303. As shown, either user may terminate the chat in this fashion.

The signal to end the communication session is received by the chat trustlet 215 or 409 on the computer 301 or 303 of the user terminating the chat. A Chat Stop message is then generated by the chat trustlet 215 or 409. In the exemplary embodiment, the Chat Stop message is of the following form:

ChatStop ::= SEQUENCE {

version ChatStopVersion

}
ChatStopVersion ::= INTEGER (RANGE(1..255))

{ csVer1 (1) } ( csVer1 )

Ver1 is an integer number that reflects the version of the ChatStop message to which the message corresponds. This number is provided to allow compatibility between different versions of the application and trustlet software if the format of the ChatStop changes over time in new versions of the chat application and/or chat trustlet. In the exemplary embodiment, csVer1 is 1.

The Chat Stop message is then transmitted to the chat application 207 or 407 on the computer 301 or 303 of the terminating user. The message is then transmitted over network 109, where is received by the computer of the non-terminating user. In the exemplary embodiment, the Chat Stop message is received by the chat application 207 or 407 of the non-terminating user, which transmits the message to the chat trustlet 215 or 409 of the non-terminating user. Once the Chat Stop message is received, the chat session is ended, which in the exemplary embodiment, includes discarding the session key.

Although the present invention has been described in detail with reference to exemplary embodiments thereof, it should be understood that various changes, substitutions and altertions can be made hereto without departing from the scope or spirit of the invention, the scope being defined by the appended claims. For instance, rather than using the present invention to communicate text entries from a human interpretable data input device, the invention could be utilized to transmit video, audio or other data from other suitable human interpretable data input devices, such as a digital camera and/or a microphone to an appropriate output device such as a display screen or audio speaker, respectively.

Additionally, the destination apparatus need not be operated by a human user, but could simply be a machine that stores the encrypted communications, such as for later review or later transmission.

Further, the human interpretable data device need not be directly coupled to the general purpose processor as long as the input device may be authenticated as a trusted device, as described in U.S. Pat. No. 6,138,239, previously incorporated by reference herein.

Finally, although in the preferred embodiment, the communication session occurs between two entities, such as users at two computers, the communications session could occur between a plurality of entities. For example, a plurality of users could securely communicate in a “chat room” or in another well known fashion enabling multiple entities to exchange data in nearly simultaneous fashion. In that instance, a user wishing to join the secure chat could authenticate himself to one of the chat participants in the manner described above with reference to FIG. 4. Upon authentication, the chat participant could securely transmit the secure chat session key to the user wishing to join the chat, thereby enabling the user to encrypt and decrypt messages among the participants in the secure chat. In this embodiment, it may be advantageous to require all participants in the secure chat to authenticate the identity of the user wishing to join before the chat session key is provided.

Numerous other applications of the present invention will be apparent to one of ordinary skill in the art.

We claim:

1. An apparatus for securely communicating with a remote apparatus, comprising:
a general purpose processor;
a security processor;
a secure memory, coupled to said security processor;
a human interpretable data input device, coupled to said security processor, for receiving secure human interpretable data and insecure human interpretable data;
a cryptographic module, coupled to said security processor, for encrypting human interpretable data received from said human interpretable data input device;
an interface, coupled to said security processor and said general purpose processor, for interfacing said security processor with said general purpose processor, the interface including an interface protocol for restricting the extent of access by the general purpose processor to said human interpretable data present in said secure memory so that said general purpose computer is able to access said secure human interpretable data only after said secure human interpretable data has been encrypted and is able to access said insecure human interpretable data in unencrypted form for processing; and
a transmitter, coupled to said general purpose processor, for transmitting said encrypted secure human interpretable data over a communications path to said remote apparatus.

2. The apparatus of claim 1, further comprising:
a secure human interpretable data output device for rendering said secure human interpretable data for presentation to a user.

3. The apparatus of claim 2, wherein said secure human interpretable data output device is a secure display.

4. The apparatus of claim 1, wherein said communication path is a computer network.

5. The apparatus of claim 4, wherein said computer network is the Internet.

6. The apparatus of claim 1, wherein said human interpretable data device is a keyboard.

7. The apparatus of claim 6, wherein said security processor, secure memory, human interpretable data device, cryptographic module and interface are integrated into a single secure keyboard unit.

8. An apparatus for secure communications, comprising:
at least two computers, comprising a first computer and a second computer, each one of said at least two computers comprising:
a general purpose processor;
a security processor;
a secure memory, coupled to said security processor;
a human interpretable data input device, coupled to said security processor, for receiving secure human interpretable data and insecure human interpretable data;
a secure human interpretable data output device, coupled to said secure processor for rendering and presenting secure human interpretable data to a user;
a cryptographic module, coupled to said security processor, for encrypting human interpretable data received from said human interpretable data input device;
an interface, coupled to said security processor and said general purpose processor, for interfacing said security processor with said general purpose processor, the interface including an interface protocol for restricting the extent of access by the general purpose processor to said human interpretable data present in said secure memory so that said general purpose computer is able to access said secure human interpretable data only after said secure human interpretable data has been encrypted and is able to access said insecure human interpretable data in unencrypted form for processing and so that said security processor has access to human interpretable data received at said general purpose processor;
a transmitter, coupled to said general purpose processor, for transmitting said encrypted secure human interpretable data over a communications path; and
a receiver, coupled to said general purpose processor, for receiving said encrypted secure human interpretable data over said communications path,
whereby secure human interpretable data entered via said human interpretable data input device at said first computer is securely transmitted to said second computer for rendering and presentation by said secure human interpretable data output device of said second computer to a user at said second computer, and responsive human interpretable data is entered via said human interpretable data input device at said second computer and securely transmitted to said first computer for rendering and presentation by said secure human interpretable data output device of said first computer to a user at said first computer.

9. The apparatus for secure communications of claim 8, wherein said at least two computers includes a third computer, and wherein secure human interpretable data entered via said human interpretable data input device at said first computer is securely transmitted to said second and third computers for rendering and presentation by said secure human interpretable data output device of said second and third computers to a user at each of said second and third computers.

10. A method for securely communicating with a remote apparatus, comprising:
a) providing a general purpose processor;
b) providing a security processor;
c) receiving, by said security processor, human interpretable data entered at a human interpretable data device;
d) determining, by said security processor, whether said human interpretable data is secure data or insecure data;
e) encrypting said human interpretable data if the result of said step d) is that said human interpretable data is secure;
f) allowing, by said security processor, said general purpose processor to access said human interpretable data in unencrypted form if the result of step d) is that said human interpretable data is insecure and otherwise allowing said general purpose process to access said human interpretable data only in encrypted form; and
g) transmitting, by said general purpose processor, said encrypted human interpretable data to said remote apparatus over a communications path.

11. A method for securely communicating with a remote apparatus, comprising:
a) providing a general purpose processor;
b) providing a security processor;
c) providing a secure memory, coupled to said security processor;
d) receiving, by said general purpose processor, encrypted human interpretable data from said remote apparatus;
e) transmitting said encrypted human interpretable data to said security processor via an interface that prevents said general purpose processor from having access to said human interpretable data in unencrypted form;
f) decrypting said human interpretable data; and
g) storing said decrypted human interpretable data in said secure memory.

12. The method of claim 11, further comprising:
g) providing a secure human interpretable data output device, coupled to said security processor and said secure memory; and
h) rendering and presenting said human interpretable data in said secure memory, by said secure human interpretable data output device, to a user.

13. In a system having a general purpose processor and a security processor, a method for initiating and conducting a secure communications session between a initiating user and a destination entity, comprising:
a) transmitting a request for a chat invitation message from said general purpose processor to said security processor;
b) generating a chat invitation message by said security processor;
c) transmitting said chat invitation message generated in step b) to said destination entity;
d) receiving a chat challenge message from said destination entity, in response to said chat invitation message, said chat challenge message comprising a random data sequence;
e) generating a chat response message by said security processor comprising digitally signing said random data sequence received in step d) with a private key associated with said initiating user;
f) transmitting said chat response message to said destination entity;
g) receiving a chat accepted message from said remote apparatus, in response to said chat response message, said chat accepted message comprising a communications key encrypted using a public key associated with said initiating user;
h) validating said chat accepted message by said security processor, comprising decrypting said communications key using said private key associate with said initiating user;
i) encrypting at least one message by said security processor using said communications key; and
j) transmitting said at least one encrypted message to said destination entity.

14. In a system having a general purpose processor and a security processor, a method for initiating and conducting a secure communications session between a initiating user at an initiating system and a destination entity, comprising:
a) receiving a chat invitation message from said initiating system;
b) generating a chat challenge message, by said security processor of said destination entity, in response to said chat invitation message, said chat challenge message comprising a random data sequence;
c) transmitting said chat challenge message to said initiating system;
d) receiving a chat response message from said initiating user, comprising said random data sequence digitally signed with a private key associated with said initiating user;
e) validating said chat response message by said security processor comprising verifying said signed random data sequence received in step d) is identical to said random data sequence generated in step b);
f) generating a chat accepted message by said security processor if said chat response message was verified, said chat accepted message comprising a communications key encrypted using a public key associated with said initiating user;
g) transmitting said chat accepted message to said initiating system;
h) receiving at least one message by said security processor; and
i) decrypting said at least one message by said security processor using said communications key.
